(19) United States
(12) Patent Application Publication
(10) Pub. No.: US 2006/0008578 A1
(43) Pub. Date: Jan. 12, 2006

(54) Method of fabricating electrode structure of field-emission display

(76) Inventors: Jin-Shou Fang, Guanyin Township (TW); Jui-Ting Hsu, Guanyin Township (TW)

Correspondence Address: Yi-Wen Tseng, 4331 Stevens Battle Lane, Fairfax, VA, 22033, US

(21) Appl. No.: 10/886,598

(22) Filed: Jul. 9, 2004

(51) Int. Cl. B05D 5/12; B05D 3/02; B05D 5/00; B05D 1/40

(52) U.S. Cl. 427/77; 427/372.2; 427/256; 427/331

(57) ABSTRACT

A method of fabricating a cathode structure of a field-emission display. Screen printing or thick-film photolithography technique is employed to apply low-cost silver ink on a substrate. The silver ink formed on the substrate serves as an electrode layer. The silver ink contains particles with diameters ranged between 0.1 microns to 10 microns. Sintering process is performed to convert the particles into crystals having diameters ranged between 1 micron and 10 microns. The electrode layer is then polished to a planarity uniformity error under 0.1 microns.

### BACKGROUND OF THE INVENTION

The present invention relates in general to a method of fabricating an electrode structure of a field-emission display, and more particularly, to a method of polishing an electrode layer made of low-cost silver ink, by which the planarity of the electrode layer is improved.

The conventional method for forming the electrode layer and the electron emission layer of a cathode of a field-emission display typically uses thin-film or thick-film technique. The thin-film technique normally provides higher planarity and precision. However, it is more costly compared to the thick-film technique which uses low-cost process such as screen printing or thick-film photolithography for fabricating partial structure of the field-emission display as disclosed in the Taiwanese Patent No. 502395 and 511108, for example.

In the example of forming the electrode layers of the cathode of a field-emission display by screen printing or thin-film photolithography, silver ink is printed and patterned, followed by printing ink containing carbon nanotube for forming an electron emission source. Alternatively, the electron emission source can be formed by spray, photolithography, electrophoresis or other electrochemical process.

The above thin-film photolithography including sputtering or evaporation for forming an electrode layer is very costly. Although a great planarity is obtained, the thickness of the film is typically limited to tens or hundreds of nanometers. Under a high voltage, the electrode often flares or broke down. The thick-film technique provides a thickness of the electrode layer up to about 1 micron. The hardness and breakdown voltage also meet with the circuit requirements. Therefore, thick-film technique has been commonly used for forming the electrode layers of the field-emission display.

Although screen printing can greatly reduce fabrication cost, such process is restricted to reticulation, knots and emulsion to result in non-uniform planarity. The accumulated planarity error of the stack of the electrode layers can be more than 5 microns. Microscopically, the photolithography process is also limited to the specification and cost of the material. For example, the silver ink typically used for forming the electrode layer has a grain size more than one micron, which consequently cause a planarity error over one micron.

The insufficient planarity uniformity of the electrode layer does not only result in an uneven electron-emission source, but also case light scattering in exposure step of the subsequent photolithography process. The precision of the photoresist layer formed by the photolithography process is thus greatly degraded.

### BRIEF SUMMARY OF THE INVENTION

The present invention uses surface polishing technique following formation of an electrode layer of a field-emission display fabricated from low-cost ink material by thick-film technique, such that the planarity of the electrode layer is enhanced, and the subsequent process can be performed with higher precision.

As provided, screen-printing technique or a thick-film technique is used to apply low-cost silver ink on a substrate to form an electrode layer. The silver ink includes particles having diameters ranged between 0.1 microns and 10 microns. By a sintering process, the particles of the silver ink are converted into crystals with diameters between one micron and 10 micron. The electrode layer made of the silver ink is the polished to control the surface planarity error under 0.1 microns.

### BRIEF DESCRIPTION OF THE DRAWINGS

The above objects and advantages of the present invention will be become more apparent by describing in detail exemplary embodiments thereof with reference to the attached drawings in which:

FIG. 1 is process flow showing the method of fabricating an electrode layer of a field-emission display;

FIG. 2 shows the electrode layer;

FIG. 3 shows the polishing process performed on the electrode layer; and

FIG. 4 illustrates the polished electrode layer.

### DETAILED DESCRIPTION OF THE INVENTION

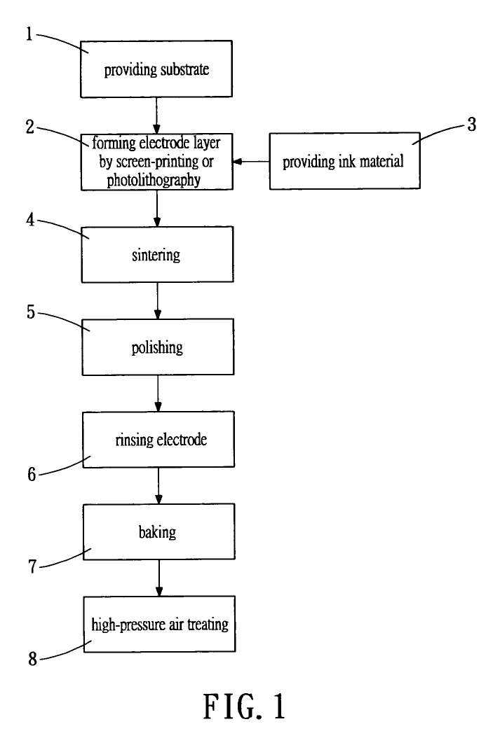

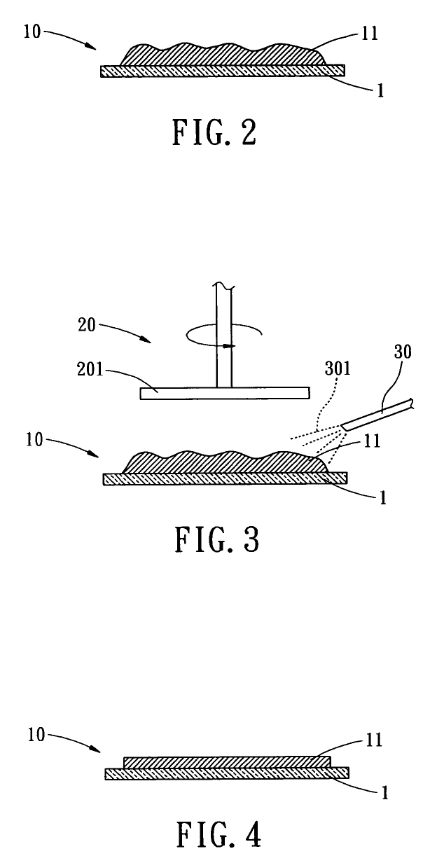

Referring to FIGS. 1 and 2, as provided, the method for fabricating an electrode structure of a field-emission display includes polishing the electrode layer to enhance the planarity thereof.

To fabricate the electrode structure, a substrate 1 such as a glass is provided.

An electrode layer 11 is formed on the substrate 1 by screen-printing or photolithography 2. A low-cost silver ink 3 is selected as the material for forming the electrode layer 11. The silver ink includes particles of which the diameters range from about 0.1 microns to about 10 microns, for example. It will be appreciated that particles in other sizes may also exist in the silver ink. Preferably, the ink 3 includes silver particles and glass particles having diameters ranging between 2 microns and 6 microns.

When the silver ink 3 is patterned to form the electrode layer 11, a sintering process 4 is performed at a predetermined temperature. In this embodiment, the predetermined temperature is about 400° C. After the sintering process, the particles of the electrode layer 11 are converted to crystal grains having diameters between about one micron and about 10 microns. Preferably, the diameters range from 2 microns to 3 microns.

A polishing step 5 is then performed on the electrode layer 11, such that the surface planarity error can be controlled under 0.1 microns.

After the polishing step, the electrode is rinsed by water 6, baked 7, and subjected to a high-pressure air 8 to remove any unwanted residual medium or particles thereon. The cathode structure of the field-emission display is thus formed.

Referring to FIGS. 3 and 4, when the electrode structure 10 is formed, a polishing member 201 of a polisher 20 is used to perform polishing with a high rotation speed of about 1000 rpm. Meanwhile, polishing medium 301 is sprayed on the first and second electrode layers 11 and 12 via a spray tool 30. The polishing medium 301 includes slurry made of hard metal oxide particles suspension. The metal oxide includes aluminum oxide, zirconium oxide, manganese oxide, or selenium oxide. In this embodiment, solution of selenium oxide suspension is used as the polishing medium. The diameter of the selenium oxide particles is under 1 micron. Therefore, the planarity error can be controlled under 0.1 microns.

The polishing step provides a planarized surface of the electrode layer 11, such that when a photoresist layer is formed by photolithography subsequently, scatter of exposure light is not caused by uneven surface of the electrode layer 11. Therefore, a high precision can be obtained.

While the present invention has been particularly shown and described with reference to preferred embodiments thereof, it will be understood by those of ordinary skill in the art the various changes in form and details may be made therein without departing from the spirit and scope of the present invention as defined by the appended claims.

What is claimed is:

1. A method of fabricating an electrode structure of a field-emission display, comprising:
screen printing an ink on a substrate to form an electrode layer;
performing sintering process; and
polishing the electrode layer.

2. The method of claim 1, further comprising providing a glass to serve as the substrate.

3. The method of claim 1, further comprising screen printing an ink having particles with diameters ranging between about 0.1 microns and about 10 microns.

4. The method of claim 1, further comprising screen printing a silver ink on the substrate.

5. The method of claim 1, wherein the sintering process is performed at a predetermined temperature.

6. The method of claim 6, wherein the predetermined temperature is about 400° C.

7. The method of claim 1, further comprising polishing the electrode layer with a planarity error lower than about 0.1 microns.

8. The method of claim 1, further comprising the steps of rinsing, baking and applying high-pressure air to the electrode layer.

9. The method of claim 1, further comprising using a polishing member to polish the electrode layer.

10. The method of claim 1, wherein the polishing member includes a wool polishing pad.

11. The method of claim 1, further comprising using a spray tool for spraying a polishing medium on the electrode layer during the polishing step.

12. The method of claim 11, wherein the polishing medium includes high hardness metal oxide suspension solution.

13. The method of claim 11, wherein the metal oxide includes aluminum oxide, zirconium oxide, manganese oxide or selenium oxide.

14. The method of claim 11, wherein the metal oxide is in the form of particle having a diameter smaller than 1 micron.

15. A method of fabricating an electrode structure, comprising:
providing a substrate;
using photolithography to form and pattern an ink, so as to form an electrode layer on the substrate;
performing sintering on the electrode layer; and
performing surface polishing on the electrode layer.
